(19) United States
(12) Patent Application Publication
(10) Pub. No.: US 2010/0185598 A1
(43) Pub. Date: Jul. 22, 2010

(54) METADATA ASSOCIATED WITH A PRINTED IMAGE

(76) Inventors: Hannu Saarelma, Helsinki (FI); Pirkko Oittinen, Helsinki (FI); Ville Rantanen, Espoo (FI)

Correspondence Address: FAY SHARPE LLP, 1228 Euclid Avenue, 5th Floor, The Halle Building, Cleveland, OH, 44115, US

(21) Appl. No.: 12/160,490

(22) PCT Filed: Jan. 10, 2007
(86) PCT No.: PCT/FI2007/000009

§ 371 Date: Mar. 29, 2010

(30) Foreign Application Priority Data
Jan. 13, 2006 (FI) 20060028

(51) Int. Cl. G06F 17/30

(52) U.S. Cl. 707/705; 707/E17.019

(57) ABSTRACT

The present invention relates to utilization of metadata associated with a printed image. Portions of images and metadata are stored, each of the metadata being associated with a portion of the images. Imaging means are used to read a portion of the printed image. Correspondence between the read portion and the stored portions is determined. Metadata associated with a stored portion is retrieved in response to the determined correspondence between the read portion and the stored portion in question exceeding a predetermined threshold value. Further, the retrieved metadata or additional data indicated by it is retrieved.

### FIELD OF THE INVENTION

The invention relates to printed images. In particular, the invention relates to the utilization of the metadata associated with printed images.

### STATE OF THE ART

Known in prior art are various optically readable graphic codes that can be pressed or printed on a substrate material and by means of which it is possible to retrieve additional information e.g. from the Internet.

These optically readable graphic codes include various bar and matrix codes. Some of these codes are one-dimensional, i.e. they comprise a number of code elements extending in one dimension. Typically, the code elements of such a one-dimensional code are line-like, whereby the code is generally referred to as a bar code. In recent years, also two-dimensional codes have become common. A two-dimensional code comprises a number of codes elements extending in two dimensions. Typically, the code elements of such a two-dimensional code are line-like or dot-like. A two-dimensional code is generally referred to as a matrix code. Examples of prior-art matrix codes include the QR code (Quick Response, QR), Data Matrix Code and PDF417 code (Portable Data File, PDF).

Typically, such a code is pressed or printed on a substrate material, such as paper, from which it is read by an optical reader designed for the purpose. Often, the code is not printed on a substrate material alone but it is incorporated into a printed publication containing, besides the code, also other information, such as text and images. Besides an advertising copy or an advertising image designed to be read by a human being, it is possible to print on an advertising leaflet also an optically readable matrix code that can be read by a camera integrated within a mobile station, in which case additional information associated with the advertisement will be displayed on the mobile station.

A problem with these known arrangements is, however, the fact that deciphering various optically readable graphic codes requires pattern recognition, which in turn consumes computation resources. Further, various optically readable graphic codes such as bar and matrix codes are typically seen as esthetically disturbing, which limits their use e.g. in advertising.

In other words, there is a need for an arrangement that makes it possible to retrieve information pre-associated with a printed image, such as a photograph in a printed publication, from a data network based on the printed image itself without a need for a bar, matrix or other graphic code associated with said image.

### OBJECTIVE OF THE INVENTION

The objective of the present invention is to disclose a novel method and system that eliminate the aforementioned disadvantages or at least significantly alleviate them. One specific objective of the invention is to disclose a method, a system and a computer program that enable utilization of metadata associated with a printed image.

### SUMMARY OF THE INVENTION

According to a first aspect of the present invention, there is presented a method for utilizing metadata associated with a printed image. In the method, predetermined portions from a set of images, and a number of predetermined pieces of metadata are stored, each of the pieces of metadata being associated with at least one of the portions of the images. Further, in the method, imaging means are used to read a predetermined portion of an image printed on a substrate material. Further, in the method, correspondence between the read portion of the printed image and at least one of the stored image portions is determined. Further, in the method, in response to the determined correspondence between the read portion of the printed image and a stored image portion exceeding a predetermined threshold value, metadata associated with the stored image portion is retrieved. Further, in the method, at least one of the following is retrieved: the retrieved metadata and additional information indicated by the retrieved metadata.

According to a second aspect of the present invention, there is presented a system for utilizing metadata associated with a printed image. The system comprises a database for storing predetermined portions from a set of images, and for storing a number of predetermined pieces of metadata, each of the pieces of metadata associated with at least one of the image portions. The system further comprises imaging means for reading a predetermined portion of an image printed on a substrate material. The system further comprises a correspondence determiner for determining correspondence between the read portion of the printed image and at least one of the stored image portions. The system further comprises a metadata retriever for retrieving metadata associated with a stored image portion from the database in response to the determined correspondence between the read portion of the printed image and the stored image portion exceeding a predetermined threshold value. The system further comprises display means for displaying at least one of the following: the retrieved metadata and additional information indicated by the retrieved metadata.

According to a third aspect of the present invention, there is presented a computer program for utilizing metadata associated with a printed image. The computer program comprises program code stored on at least one data processor readable medium, the program code arranged to execute the following steps when executed in a data processor:
controlling imaging means to read a predetermined portion of an image printed on a substrate material;
determining correspondence between the read portion of the printed image and at least one of the stored image portions, wherein predetermined portions from a set of images and a number of predetermined pieces of metadata have been stored at a database, each of the pieces of metadata associated with at least one of the image portions;
retrieving metadata associated with a stored image portion in response to the determined correspondence between the read portion of the printed image and the stored image portion exceeding a predetermined threshold value; and
controlling display means to display at least one of the following: the retrieved metadata and additional information indicated by the retrieved metadata.

In one embodiment of the invention, at least one stored portion of an image comprises one of the following: at least one scanning line of said image, a segment of said image, and a reduced-resolution copy of said image.

In one embodiment of the invention, the read portion of the printed image comprises one of the following: at least one scanning line of said image, a segment of said image, and a reduced-resolution copy of said image.

Compared to the prior art, the present invention provides the advantage that it enables one to retrieve information pre-associated with a printed image, such as a photograph in a printed publication, from a data network based on the printed image itself without a need for a bar, matrix or any graphic code or identifier associated with the image in question. As a result of this, the invention makes the pattern recognition associated with the deciphering of various optically readable graphic codes such as bar and matrix codes unnecessary, thereby reducing computation resources. Further, the solution of the invention can be applied e.g. in advertising in a considerably more versatile manner than various bar and matrix codes, because the solution of the invention is not esthetically disturbing contrary to these codes in accordance with the prior art.

### LIST OF FIGURES

In the following section, the invention will be described by means of the attached examples of its embodiments referring to the attached drawing, in which

FIG. 1 schematically represents a method of the invention; and

FIG. 2 schematically represents a system of the invention.

### DETAILED DESCRIPTION OF THE INVENTION

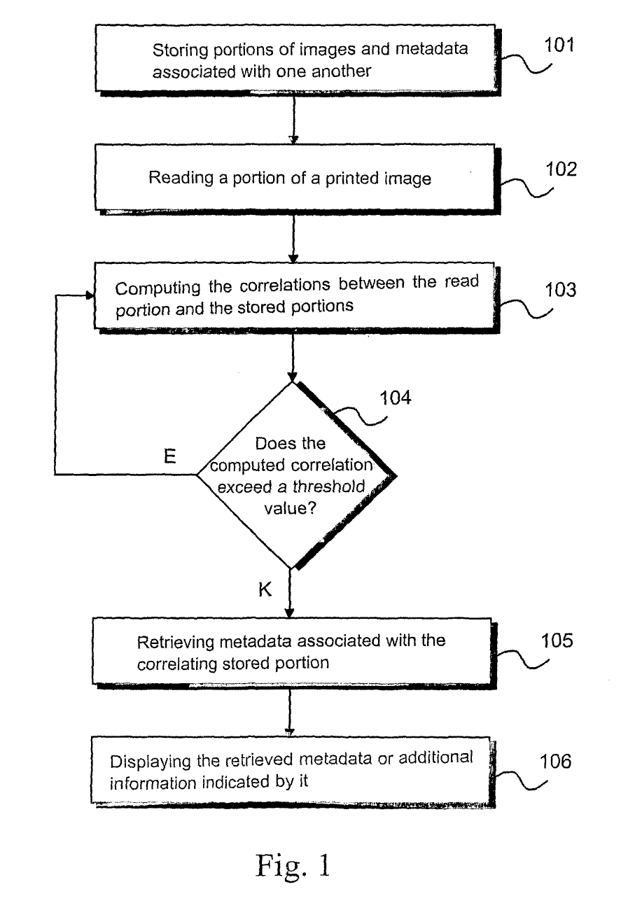

FIG. 1 is a flow chart illustrating, by way of example, one method of the invention, by means of which it is possible to utilize metadata associated with a printed image.

At step 101 of the method presented in FIG. 1, predetermined portions from a set of images and a number of predetermined pieces of metadata are stored, each of the pieces of metadata associated with at least one of the portions of the images.

Next, imaging means are used to read a predetermined portion of an image printed on a substrate material, step 102. It must be noted that the term “to print” is used in conjunction with the invention in the broad sense of the term in question, so that it also includes various printing and pressing techniques.

Next in the invention, correspondence between the read portion of the printed image and at least one of the stored image portions is determined. This correspondence can be determined e.g. by computing correlation between the aforementioned read portion of the printed image and the at least one stored image portion, like in the example of FIG. 1, where computing correlations between the read portion of the printed image and the stored image portions is started at step 103. Once the correlation between a first stored image portion and the read portion of the printed image has been computed, it is determined at step 104 whether this first computed correlation exceeds a predetermined threshold value. In case the threshold value is exceeded, the method proceeds to step 105. In case the threshold value is not exceeded, the method returns back to step 103, where correlation between a second stored image portion and the read portion of the printed image is computed, and the method proceeds again to step 104 to determine whether this second computed correlation exceeds the predetermined threshold value. The loop of steps 103 and 104 is repeated until one finds such a stored image portion whose correlation with the read portion of the printed image exceeds the predetermined threshold value in question or until the stored image portions have been gone through and a correlating portion has not been found.

At step 105 of the method presented in FIG. 1, metadata attached to the correlating stored image portion found above is retrieved. Finally, at step 106, at least one of the following is displayed: the retrieved metadata and additional information indicated by the retrieved metadata.

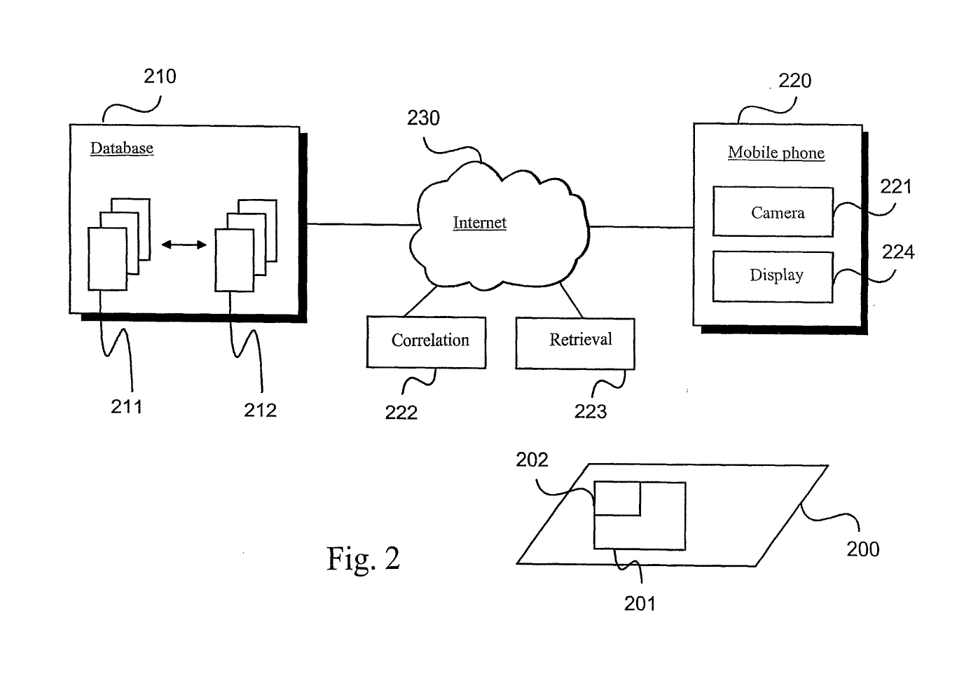

FIG. 2 is a block diagram illustrating, by way of example, one system of the invention, by means of which it is possible to utilize metadata associated with a printed image.

The system presented in FIG. 2 comprises an image 201 printed on a substrate material 200 as well as a predetermined portion 202 of this image. The substrate material may include paper, film, plastic or some other material known per se that is suited for printing. The predetermined portion 202 of the printed image 201 may comprise e.g. at least one scanning line of the image 201. Alternatively, the predetermined portion 202 of the printed image 201 may comprise e.g. some segment of the image 201, such as the left-hand upper quarter of the image 201 shown in FIG. 2. it must be noted that this segment may also include the entire printed image 201; in other words, in one embodiment of the invention, the portion 202 may comprise the entire image 201. Alternatively, the predetermined portion 202 of the printed image 201 may comprise a reduced-resolution copy of the image 201. This reduced-resolution copy of the printed image 201 may be provided e.g. by filtering the image 201 down to e.g. a 100×100 pixel image.

The system further comprises a database 210. Stored at the database 210 are predetermined portions 211 from a set of images. Similarly to the predetermined portion 202 of the printed image 201, also the predetermined portions 211 of the set of images stored at the database 210 may each comprise at least one scanning line of a respective image in the set of images in question. Alternatively, the predetermined portions 211 of the set of images stored at the database 210 may each comprise e.g. a segment of the respective image in the set of images in question, such as the left-hand side upper quarter of each image. It must be noted that this segment may also include the respective image entirely. Alternatively, the predetermined portions 211 of the set of images stored at the database 210 may each comprise a reduced-resolution copy of the respective image in the set of images. These reduced-resolution copies may be provided e.g. by filtering each image in the set of images down to e.g. a 100×100 pixel image.

Naturally, the portion 202 of the printed image 201 and the portions 211 in the set of images stored at the database 210 shall be predetermined so that they are equivalent (i.e. from the stored images and from the printed image, the same scanning line(s) or spatially the same segment or copies with the same reduced resolution are selected) to allow a correlation counter 222 to compute the correlation between the read portion 202 of the printed image 201 and at least one stored image portion 211.

Further, stored at the database 210 is a number of predetermined pieces of metadata 212. Each of the pieces of metadata 212 is associated with at least one image portion 211. At least one of the pieces of metadata 212 may comprise e.g. information on the subject matter of the image of the set of images with whose portion the piece of metadata in question is associated. If a piece of metadata 212 is associated e.g. with a portion of a news image, then the piece of metadata in question may comprise information on this piece of news. Further, at least one of the pieces of metadata 212 may comprise e.g. a URL address. If a piece of metadata 212 is associated e.g. with a portion of an image that advertises a product or a service, then the piece of metadata in question may contain a URL address (Uniform Resource Locator, URL), at which additional information on the product or service in question may be obtained.

The database 210 may be a personal one, or the database may be maintained by a company, such as a publisher or a photo agency. Further, the database 210 may be a global database distributed in a network, whereby it may be linked e.g. with a search engine service. In the last-mentioned case, the pieces of metadata 212 may be entered manually e.g. so that a camera automatically registers the time and place of shooting a photograph e.g. by means of the GPS system (Global Positioning System, GPS), and at the moment of shooting, the photographer dictates information on the subject matter of the photograph, which dictated information is then digitized and converted into alpha-numeric form.

The system shown in FIG. 2 by way of example further comprises a mobile phone 220 comprising imaging means 221 for reading the predetermined portion 202 of the image 201 printed on the substrate material 200. In the example of FIG. 2, the imaging means 221 comprise a camera integrated with the mobile phone 220. The imaging means 221, display 224, the correlation counter 222, metadata retriever 223 and the database 210 are connected to one another e.g. via a data network such as the Internet 230. If, for example, the imaging means 221 and the display 224 are integrated with the mobile phone, such as in the example of FIG. 2, then this data network can, in addition, comprise a wireless connection, such as a GPRS connection (General Packet Radio Service, GPRS).

The system further comprises a correspondence determiner 222 for determining correspondence between the read portion 202 of the printed image 201 and at least one stored image portion 211. This correspondence determiner can be e.g. a correlation counter 222 for computing correlation between the read portion 202 of the printed image 201 and the at least one stored image portion 211, such as in the example of FIG. 2. Moreover, the system comprises a metadata retriever 223 for retrieving the metadata associated with a stored image portion 211 from the database 210 in case the correlation computed between the read portion 202 of the printed image 201 and the stored image portion 211 in question exceeds a predetermined threshold value. The purpose of computing the correlation is to find in the database 210 a stored portion that would correspond to the portion 202 of the printed image 201 that has been read. As is known to a person skilled in the art, the adjacent pixels of real images often have a strong positive correlation, and the images involve noise i.e. non-desired variation of colors and density. The noise does not change while the image is in an electronic form, but more noise is generated when the image is printed and the printout is read. In practice, these things reduce the number of images different from each other. However, as an image taken with a camera integrated e.g. with a mobile phone typically has 1000×1000 pixels and each pixel has a bit depth of 24 bits, there is such a big number of various possible images that the error limits of computing the correlation remain very small in practice. The correlation counter 222 and the metadata retriever 223 can be implemented via software or hardware or as a combination of these. Further, the correlation counter 222 and the metadata retriever 223 can be implemented separately from the database 210 and the mobile phone 220, as is shown in the example of FIG. 2. Alternatively, the correlation counter 222 and/or the metadata retriever 223 can be arranged in conjunction with the database 210 or the mobile phone 220.

The system further comprises the display means 224 for displaying at least one of the following: the retrieved metadata 212 and additional information indicated by the retrieved metadata 212. The retrieved metadata 212 can include e.g. above-described information on the subject matter of the image. When the retrieved metadata 212 is e.g. a URL address, the additional information indicated by the retrieved metadata 212 can include the additional information that can be obtained at the URL address in question. In the example of FIG. 2, the imaging means 224 comprise a display integrated within the mobile phone 220.

The arrangement of the present invention can be utilized in many different applications. Applications such as these include the use of sales catalogues or advertisements to identify a product about which there is a wish to obtain more information or which one wants to buy. Further, applications such as these include photographs of a guidebook that act as an address to route, price and/or time information. Further, applications such as these include an image printed in a magazine that is read e.g. by a camera integrated within a mobile phone, which opens a network address to the web site of the same magazine with additional information on the subject matter in question.

The invention is not limited merely to the examples of its embodiments referred to above, but many modifications are possible within the scope of the inventive idea defined by the claims.

1. A method for utilizing metadata associated with a printed image, characterized in that the method comprises the steps of:
storing predetermined portions from a set of images and a number of predetermined pieces of metadata, each of the pieces of metadata associated with at least one of the portions of the images;
reading by imaging means a predetermined portion of an image printed on a substrate material; determining correspondence between the read portion of the printed image and at least one of the stored image portions;
retrieving metadata associated with a stored image portion in response to the determined correspondence between the read portion of the printed image and said stored image portion exceeding a predetermined threshold value; and
displaying at least one of the following: the retrieved metadata and additional information indicated by the retrieved metadata.

2. A system for utilizing metadata associated with a printed image, characterized in that the system comprises:
a database (210) for storing predetermined portions from a set of images and a number of predetermined pieces of metadata, each of the pieces of metadata associated with at least one of the portions of the images;
imaging means (221) for reading a predetermined portion of an image printed on a substrate material;
a correspondence determiner (222) for determining correspondence between the read portion of the printed image and at least one of the stored image portions;
a metadata retriever (223) for retrieving
metadata associated with a stored image portion from the database in response to the determined correspondence between the read portion of the printed image and said stored image portion exceeding a predetermined threshold value; and
display means (224) for displaying at least one of the following: the retrieved metadata and additional information indicated by the retrieved metadata.

3. The system as defined in claim 2,
characterized in that at least one stored portion of an image comprises one of the following: at least one scanning line of said image, a segment of said image, and a reduced-resolution copy of said image.

4. The system as defined in claim 2, characterized in that the read portion of the printed image comprises one of the following: at least one scanning line of said image, a segment of said image, and a reduced-resolution copy of said image.

5. A computer program for utilizing metadata associated with a printed image, characterized in that the computer program comprises program code stored on at least one data processor readable medium, the program code arranged to execute the following steps when executed in a data processor:
controlling imaging means to read a predetermined portion of an image printed on a substrate material;
determining correspondence between the read portion of the printed image and at least one of the stored image portions, wherein predetermined portions from a set of images and a number of predetermined pieces of metadata have been stored at a database, each of the pieces of metadata being associated with at least one of the image portions;
retrieving metadata associated with a stored image portion in response to the determined correspondence between the read portion of the printed image and said stored image portion exceeding a predetermined threshold value; and
controlling display means to display at least one of the following: the retrieved metadata and additional information indicated by the retrieved metadata.
